(19) United States
(12) Patent Application Publication
(10) Pub. No.: US 2010/0009213 A1
(43) Pub. Date: Jan. 14, 2010

(54) METHOD FOR PRODUCING A COMPONENT AND COMPONENT

(75) Inventors: Andreas Eipper, Ludwigshafen (DE); Mark Völkel, Ladenburg (DE); Raquel Fernandez Rofiles, Mannheim (DE); Rebekka von Benten, Mannheim (DE); Harald Kröger, Bohl-Iggelheim (DE); Michael Marius Fedler, Wuppertal (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/527,496

(22) PCT Filed: Feb. 15, 2008
(86) PCT No.: PCT/EP08/51873

§ 371 Date: Aug. 17, 2009

(30) Foreign Application Priority Data
Feb. 15, 2007 (EP) 07102450.9

(51) Int. Cl. B32B 15/08; B29C 45/16

(52) U.S. Cl. 428/615; 264/271.1; 428/357

(57) ABSTRACT

The invention relates to a process for the production of a component, comprising an insert part (1) sheathed by a plastics layer, by, in a first step, sheathing of at least one part of the insert part (1) with a plastics molding composition (2) with low viscosity and, in a second step, using a hard plastics component (3) for overmolding of the insert part with the sheathing, or by sheathing of the insert part (1) with a hard plastics component (3), regions of the insert part (1) here not being sheathed, and overmolding of the non-sheathed regions with a plastics molding composition (2) with low viscosity. The invention further relates to a component comprising an insert part and comprising plastics sheathing which is composed of at least two plastics components, where the first plastics component, which at least to some extent directly sheathes the insert part (1), is a plastics molding composition (2) with low viscosity, and the second plastics component is a hard plastics component (3).

The invention relates to a process for the production of a component, comprising an insert part sheathed by a plastics layer. The invention further relates to a component which comprises an insert part and which comprises plastics sheathing which is composed of at least two plastics components.

Many sectors of technology require sealing of components with respect to the environment. This is necessary particularly when the intention is to prevent damage within the interior of the components caused for example by aggressive fluids and/or environmental effects. However, encapsulation is generally not possible since, for example, plug connectors or lines have to be passed out of the component, and sealing at these passageways is therefore particularly necessary.

DE-A 103 13 833 discloses by way of example the sealing of a line passed through an opening in a wall element. For sealing of the passageway in a wall element composed of a plastic, a hot-melt adhesive is used whose shear modulus is less than 500 N/mm² (at 0° C.) and whose HDT B (ISO 75-2) heat distortion temperature is more than 230° C.

AT-A 501 010 discloses by way of example another component, in which electrical conductors are passed through a wall of a plastics housing. For this, the plastics housing in the region of the conductor is designed to have two walls, being composed of an inner wall and of an outer wall, and in the space between the inner and the outer wall there is a permanently flexible material arranged which completely surrounds the conductor.

EP-A 1 174 237 discloses an electrical device with a housing composed of a hardened polymeric material. The arrangement has, within the housing, an electrical component connected via at least one electrical line to at least one electrical component arranged outside or inside of the housing. The line is of flexible design and is at least to some extent embedded into the wall of the housing during the shaping and hardening of the housing.

A disadvantage of the abovementioned passageways is that only a single conductor can be passed through the wall, and the overmolding material here does not usually bond to the conductor when the conductor has been incorporated into the wall by injection molding. The result here is a gap between the two materials. Capillary action can cause moisture to penetrate into the component along the gap. In particular in the case of electronic components, this moisture can cause short circuits and leakage currents, or corrosion of contacts. If, on the other hand, a plurality of conductors are passed through the wall, a complicated structure is necessary for sealing.

DE-A 198 12 880 discloses the embedding of conductor tracks into a plastics molding and a flexible foil. The molding or flexible foil described there is composed at least of a plastics foil as backing layer, a metallizable primer layer applied thereto, and a structured, metallic electrically conducting layer applied to the primer layer. There is an additional outer foil or a plastics body securely bonded to the composite composed of backing layer, primer layer, and conducting layer, the result being that the outer foil or the plastics body at least to some extent covers the conducting layer. The connection between outer foil or plastics body and the composite composed of backing layer, primer layer, and conducting layer is achieved by way of example via welding or adhesive bonding. The process described here for the production of the molding or of the flexible foil is very complicated. Furthermore, there is, here again, no connection between the plastic and the metallic electrically conducting layer, and here again a gap is therefore produced, along which moisture can penetrate.

It is an object of the present invention to provide a process for the production of a component by using a plastics layer to sheathe an insert part in such a way that the component has been sealed with respect to the environment. A further object of the present invention is to provide a component which comprises an insert part surrounded by a plastics jacket, where the bond between plastics jacket and insert part is leakproof with respect to the environment.

The object is achieved via a process for the production of a component, comprising an insert part, sheathed by a plastics layer, which comprises the following steps:
(a) sheathing of the insert part with a plastics molding composition of low viscosity, and
(b) sheathing of the insert part with the sheathing composed of the plastics molding composition with a hard plastics component.

As an alternative, the object is achieved via a process for the production of a component, comprising an insert part, sheathed by a plastics layer, which comprises the following steps:
(c) sheathing of the insert part with a hard plastics component, where those regions of the insert part to be sealed with respect to the environment are not sheathed, and
(d) sheathing of the non-sheathed regions of the insert part with a plastics molding composition, where the plastics molding composition has low viscosity.

For the purposes of the present invention, low viscosity means that the viscosity number to ISO 307, measured in 96% strength sulfuric acid, is smaller than 140 ml/g.

In one preferred embodiment, the plastics molding composition which has the low viscosity is a polyamide, a polyester or a mixture from at least one polyamide and at least one polyester.

In case the plastics molding composition which has the low viscosity is a polyamide, it is particularly preferably a polyamide copolymer. The polyamide copolymer is preferably prepared via polymerization of at least two monomers selected from the group consisting of caprolactam, adipic acid, hexamethylenediamine, and bis(4-aminocyclohexyl)methane. The polyamide is particularly preferably prepared via polymerization of caprolactam, adipic acid, hexamethylenediamine, and bis(4-aminocyclohexyl)methane.

As polyamide also mixtures from at least two different polyamides can be employed.

Suitable polyesters as plastics molding composition which has the low viscosity are for example aliphatic polyesters or polyesters based on aliphatic and aromatic dicarboxylic acids, and on aliphatic dihydroxy compounds.

Preferably the polyester is comprised of:
A) an acid component composed of
   a1) from 30 to 99 mol % of at least one aliphatic, or at least one cycloaliphatic, dicarboxylic acid, or its ester-forming derivatives, or a mixture of these
   a2) from 1 to 70 mol % of at least one aromatic dicarboxylic acid, or its ester-forming derivative, or a mixture of these, and
   a3) from 0 to 5 mol % of a sulfonate-group-containing compound,
      where the molar percentages of components a1) to a3) together give 100%, and
B) a diol component composed of at least one C₂-C₁₂ alkanediol or of at least one C₅-C₁₀ cycloalkanediol, or mixtures of these, and, if desired, also one or more components selected from
C) a component selected from the group consisting of
   c1) at least one dihydroxy compound containing ether functions and having the formula I

HO—[(CH₂)ₙ—O]ₘ—H (I)
where n is 2, 3 or 4, and m is an integer from 2 to 250,
c2) at least one hydroxycarboxylic acid of formula IIa or IIb

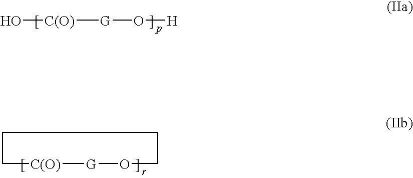

where p is an integer from 1 to 1500 and r is an integer from 1 to 4, and G is a radical selected from the group consisting of phenylene, —(CH₂)_{q}—, where q is an integer from 1 to 5, —C(R)H— and —C(R)HCH₂—, where R is methyl or ethyl,
c3) at least one amino-C₂-C₁₂ alkanol, or at least one amino-C₅-C₁₀ cycloalkanol, or a mixture of these,
c4) at least one diamino-C₁-C₈ alkane,
c5) at least one 2,2′-bisoxazoline of the formula III

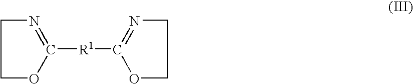

where R¹ is a single bond, (CH₂)_{z}-alkylene, where z=2, 3 or 4, or phenylene, and
c6) at least one aminocarboxylic acid selected from the group consisting of the naturally occurring amino acids, polyamides obtainable by polycondensing a dicarboxylic acid having from 4 to 6 carbon atoms with a diamine having from 4 to 10 carbon atoms, compounds of the formulae IVa and IVb

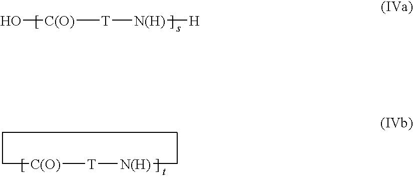

where 5 is an integer from 1 to 1500 and t is an integer from 1 to 4, and T is a radical selected from the group consisting of phenylene, —(CH₂)ᵤ—, where u is an integer from 1 to 12, —C(R²)H— and —C(R²)HCH₂—, where R² is methyl or ethyl,
and polyoxazolines having the repeat unit V

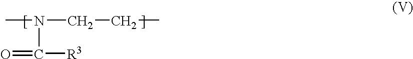

where R³ is hydrogen, C₁-C₆-alkyl, C₅-C₈-cycloalkyl, phenyl, either unsubstituted
or with up to three C₁-C₄-alkyl substituents, or tetrahydrofuryl,
or a mixture composed of c1) to c6),
and of
D) a component selected from
   d1) at least one compound having at least three groups capable of ester formation,
   d2) at least one isocyanate, and
   d3) at least one divinyl ether,
   or a mixture composed of d1) to d3).

In one preferred embodiment, the acid component A of the semiaromatic polyesters comprises from 30 to 70 mol %, in particular from 40 to 60 mol %, of a1 and from 30 to 70 mol %, in particular from 40 to 60 mol %, of a2.

Aliphatic or cycloaliphatic acids, and the corresponding derivatives, a1 which may be used are those mentioned above. Particular preference is given to the use of adipic acid or sebacic acid, or of the ester-forming derivatives of each of these, or of a mixture thereof. Particular preference is given to the use of adipic acid or of its ester-forming derivatives, for example its alkyl esters, or a mixture thereof.

Aromatic dicarboxylic acids a2 of which mention may generally be made are those having from 8 to 12 carbon atoms, and preferably those having 8 carbon atoms. By way of example, mention may be made of terephthalic acid, isophthalic acid, 2,6-naphthoic acid and 1,5-naphthoic acid, and also ester-forming derivatives thereof. Particular mention may be made here of the di-C₁-C₆-alkyl esters, e.g. dimethyl, diethyl, di-n-propyl, diisopropyl, di-n-butyl, diisobutyl, di-t-butyl, di-n-pentyl, diisopentyl, or di-n-hexyl esters. The anhydrides of the dicarboxylic acids a2 are likewise suitable ester-forming derivatives.

However, in principle use may be made of aromatic dicarboxylic acids a2 having a larger number of carbon atoms, for example up to 20 carbon atoms.

The aromatic dicarboxylic acids or ester-forming derivatives of these a2 may be used individually or as a mixture of two or more of these. It is particularly preferable to use terephthalic acid or its ester-forming derivatives, such as dimethyl terephthalate.

The compound used containing sulfonate groups is usually the alkali metal or alkaline earth metal salt of a sulfonate-containing dicarboxylic acid or ester-forming derivatives thereof, preferably alkali metal salts of 5-sulfoisophthalic acid or a mixture of these, particularly preferably the sodium salt.

In one of the preferred embodiments, the acid component A comprises from 40 to 60 mol % of a1, from 40 to 60 mol % of a2 and from 0 to 2 mol % of a3. In another preferred embodiment, the acid component A comprises from 40 to 59.9 mol % of a1, from 40 to 59.9 mol % of a2 and from 0.1 to 1 mol % of a3, in particular from 40 to 59.8 mol % of a1, from 40 to 59.8 mol % of a2 and from 0.2 to 0.5 mol % of a3.

The diols B are generally selected from the group consisting of branched or linear alkanediols having from 2 to 12 carbon atoms, preferably from 4 to 6 carbon atoms, or from the group consisting of cycloalkanediols having from 5 to 10 carbon atoms.

Examples of suitable alkanediols are ethylene glycol, 1,2-propanediol, 1,3-propanediol, 1,2-butanediol, 1,4-butanediol, 1,5-pentanediol, 2,4-dimethyl-2-ethyl-1,3-hexanediol, 2,2-dimethyl-1,3-propanediol, 2-ethyl-2-butyl-1,3-propanediol, 2-ethyl-2-isobutyl-1,3-propanediol and 2,2,4-trimethyl-1,6-hexanediol, in particular ethylene glycol, 1,3-propanediol, 1,4-butanediol or 2,2-dimethyl-1,3-propanediol (neopentyl glycol); cyclopentanediol, 1,4-cyclohexanediol, 1,2-cyclohexanedimethanol, 1,3-cyclohexanedimethanol, 1,4-cyclohexanedimethanol or 2,2,4,4-tetramethyl-1,3-cyclobutanediol. It is also possible to use mixtures of different alkanediols.

Depending on whether an excess of acid groups or of OH end groups is desired, either component A or component B may be used in excess. In one preferred embodiment, the molar ratio of the components A and B used is from 0.4:1 to 1.5:1 preferably from 0.6:1 to 1.1:1.

Besides components A and B, the polyesters on which the molding compositions of the invention are based may contain other components.

Dihydroxy compounds c1 which are preferably used are diethylene glycol, triethylene glycol, polyethylene glycol, polypropylene glycol and polytetrahydrofuran (polyTHF), particularly preferably diethylene glycol, triethylene glycol and polyethylene glycol, and mixtures of these may also be used, as may compounds which have different variables n (see formula I), for example polyethylene glycol which contains propylene units (n=3), obtainable, for example, by using methods of polymerization known per se and polymerizing first with ethylene oxide and then with propylene oxide, and particularly preferably a polymer based on polyethylene glycol with different variables n, where units formed from ethylene oxide pre-dominate. The molar mass (Mₙ) of the polyethylene glycol is generally selected within the range from 250 to 8000 g/mol, preferably from 600 to 3000 g/mol.

In one of the preferred embodiments for preparing the semiaromatic polyesters use may be made, for example, of from 15 to 98 mol %, preferably from 60 to 99.5 mol %, of the diols B and from 0.2 to 85 mol %, preferably from 0.5 to 30 mol %, of the dihydroxy compounds c1, based on the molar amount of B and c1.

In one preferred embodiment, the hydroxycarboxylic acid c2) used is: glycolic acid, D-, L- or D,L-lactic acid, 6-hydroxyhexanoic acid, cyclic derivatives of these, such as glycolide (1,4-dioxane-2,5-dione), D- or L-dilactide (3,6-dimethyl-1,4-dioxane-2,5-dione), p-hydroxybenzoic acid, or else their oligomers and polymers, such as 3-polyhydroxybutyric acid, polyhydroxyvaleric acid, polylactide (for example that obtainable in the form of EcoPLA® (Cargill)), or else a mixture of 3-polyhydroxybutyric acid and polyhydroxyvaleric acid (the latter being obtainable as Biopol® from Zeneca) and, for preparing semiaromatic polyesters, particularly preferably the low-molecular-weight and cyclic derivatives thereof.

Examples of amounts which may be used of the hydroxycarboxylic acids are from 0.01 to 50% by weight, preferably from 0.1 to 40% by weight, based on the amount of A and B.

The amino-C₂-C₁₂ alkanol or amino-C₅-C₁₀ cycloalkanol used (component c3) which for the purposes of the present invention may also be 4-aminomethylcyclohexanemethanol, is preferably amino-C₂-C₆ alkanols, such as 2-aminoethanol, 3-aminopropanol, 4-aminobutanol, 5-aminopentanol or 6-aminohexanol, or else amino-C₅-C₆ cycloalkanols, such as aminocyclopentanol and aminocyclohexanol, or a mixture of these.

The diamino-C₁-C₈ alkanes (component c4) used are preferably diamino-C₄-C₆ alkanes, such as 1,4-diaminobutane, 1,5-diaminopentane or 1,6-diaminohexane (hexamethylenediamine, HMD).

In one preferred embodiment for preparing the semiaromatic polyesters, use may be made of from 0.5 to 99.5 mol %, preferably from 0.5 to 50 mol %, of c3, based on the molar amount of B, and of from 0 to 50 mol %, preferably from 0 to 35 mol %, of c4, based on the molar amount of B.

The 2,2′-bisoxazolines c5 of the formula III are generally obtainable via the process of Angew. Chem. Int. Edit., Vol. 11 (1972), pp. 287-288. Particularly preferred bisoxazolines are those where R¹ is a single bond, (CH₂)_{z} alkylene, where z=2, 3 or 4, for example methylene, ethane-1,2-diyl, propane-1,3-diyl or propane-1,2-diyl, or a phenylene group. Particularly preferred bisoxazolines which may be mentioned are 2,2′-bis(2-oxazoline), bis(2-oxazblinyl)methane, 1,2-bis(2-oxazolinyl)ethane, 1,3-bis(2-oxazolinyl)propane and 1,4-bis(2-oxazolinyl)butane, in particular 1,4-bis(2-oxazolinyl)benzene, 1,2-bis(2-oxazolinyl)benzene or 1,3-bis(2-oxazolinyl)benzene.

In preparing the semiaromatic polyesters use may, for example, be made of from 70 to 98 mol % of B, up to 30 mol % of c3 and from 0.5 to 30 mol % of c4 and from 0.5 to 30 mol % of c5, based in each case on the total of the molar amounts of components B, c3, c4 and c5. In another preferred embodiment, use may be made of from 0.1 to 5% by weight, preferably from 0.2 to 4% by weight, of c5, based on the total weight of A and B.

The component c6 used may be naturally occurring aminocarboxylic acids. These include valine, leucine, isoleucine, threonine, methionine, phenylalanine, tryptophan, lysine, alanine, arginine, aspartamic acid, cysteine, glutamic acid, glycine, histidine, proline, serine, tyrosine, asparagin and glutamine.

Preferred aminocarboxylic acids of the formulae IVa and IVb are those where s is an integer from 1 to 1000 and t is an integer from 1 to 4, preferably 1 or 2, and T has been selected from the group consisting of phenylene and —(CH₂)ᵤ—, where u is 1, 5, or 12.

c6 may also be a polyoxazoline of the formula V. However, c6 may also be a mixture of different aminocarboxylic acids and/or polyoxazolines.

In one preferred embodiment, the amount of c6 used is from 0.01 to 50% by weight, preferably from 0.1 to 40% by weight, based on the total amount of components A and B.

Among other components which may be used, if desired, for preparing the semiaromatic polyesters are compounds d1 which contain at least three groups capable of ester formation.

The compounds d1 preferably contain from three to ten functional groups which are capable of developing ester bonds Particularly preferred compounds d1 have from three to six functional groups of this type in the molecule, in particular from three to six hydroxyl groups and/or carboxyl groups. Examples which should be mentioned are:

tartaric acid, citric acid, maleic acid;
trimethylolpropane, trimethylolethane;
pentaerythritol;
polyethertriols;
glycerol;
trimesic acid;
trimellitic acid, trimellitic anhydride;
pyromellitic acid, pyromellitic dianhydride, and
hydroxyisophthalic acid.

The amounts generally used of the compounds d1 are from 0.01 to 15 mol %, preferably from 0.05 to 10 mol %, particularly preferably from 0.1 to 4 mol %, based on component A.

Components d2 used are an isocyanate or a mixture of different isocyanates. For example, aromatic or aliphatic diisocyanates may be used. However, higher-functionality isocyanates may also be used.

For the purposes of the present invention, aromatic diisocyanate d2 is especially tolylene 2,4-diisocyanate, tolylene 2,6-diisocyanate, diphenylmethane 2,2′-diisocyanate, diphenylmethane 2,4′-diisocyanate, diphenylmethane 4,4′-diisocyanate, naphthylene 1,5-diisocyanate or xylylene diisocyanate.

Among these, particular preference is given to diphenylmethane 2,2′-, 2,4′- and 4,4′-diisocyanate as component d2. The latter diisocyanates are generally used as a mixture.

A three-ring isocyanate d2 which may also be used is tri(4-isocyanophenyl)methane. Multi-ringed aromatic diisocyanates arise during the preparation of single- or two-ring diisocyanates, for example.

Component d2 may also contain subordinate amounts, e.g. up to 5% by weight, based on the total weight of component d2, of uretdione groups, for example for capping the isocyanate groups.

For the purposes of the present invention, an aliphatic diisocyanate d2 is primarily a linear or branched alkylene diisocyanate or cycloalkylene diisocyanate having from 2 to 20 carbon atoms, preferably from 3 to 12 carbon atoms, e.g. hexamethylene 1,6-diisocyanate, isophorone diisocyanate, or methylenebis(4-isocyanatocyclohexane). Hexamethylene 1,6-diisocyanate and isophorone diisocyanate are particularly preferred aliphatic diisocyanates d2.

Among the preferred isocyanurates are the aliphatic isocyanurates which derive from C2-C20, preferably C3-C12, cycloalkylene diisocyanates or alkylene diisocyanates, e.g. isophorone diisocyanate or methylenebis(4-isocyanatocyclohexane), The alkylene diisocyanates here may be either linear or branched. Particular preference is given to isocyanurates based on n-hexamethylene diisocyanate, for example cyclic trimers, pentamers, or higher oligomers of n-hexamethylene diisocyanate.

The amounts generally used of component d2 are from 0.01 to 5 mol %, preferably from 0.05 to 4 mol %, particularly preferably from 0.1 to 4 mol %, based on the total of the molar amounts of A and B.

Divinyl ethers d3 which may be used are generally any of the customary and commercially available divinyl ethers. Preference is given to the use of 1,4-butanediol divinyl ethers, 1,6-hexanediol divinyl ethers or 1,4-cyclohexanedimethanol divinyl ethers or a mixture of these.

The amounts of the divinyl ethers preferably used are from 0.01 to 5% by weight, especially from 0.2 to 4% by weight, based on the total weight of A and B.

Examples of preferred semiaromatic polyesters are based on the following components

### A, B, d1

### A, B, d2

A, B, d1, d2

### A, B, d3

### A, B, c1

A, B, c1, d3
A, B, c3, c4
A, B, c3, c4, c5
A, B, d1, c3, c5
A, B, c3, d3
A, B, c3, d1
A, B, c1, c3, d3

### A, B, c2

Among these, particular preference is given to semiaromatic polyesters based on A, B and d1, or A, B and d2, or A, B, d1 and d2. In another preferred embodiment, the semiaromatic polyesters are based on A, B, c3, c4 and c5 or A, B, d1, c3 and c5.

The preparation of the semiaromatic polyesters is known per se or can take place by methods known per se.

The preferred semiaromatic polyesters are characterized by a molar mass (Mₙ) in the range from 1000 to 100000, in particular in the range from 9000 to 75000 g/mol, preferably in the range from 10000 to 50000 g/mol, and by a melting point in the range from 60 to 170° C., preferably in the range from 80 to 150° C.

The aliphatic and/or semiaromatic polyesters mentioned may have hydroxy and/or carboxy end groups in any desired ratio. The aliphatic and/or semiaromatic polyesters mentioned may also have been end-group-modified. For example, OH end groups may have been acid-modified by reaction with phthalic acid, phthalic anhydride, trimellitic acid, trimellitic anhydride, pyromellitic acid, or pyromellitic anhydride.

Also mixtures of two or more different polyesters can be employed.

Particularly suitable as polyester are for example polybutylene terephthalate (PBT), polyethylene terephthalate (PET), polybutylene terephthalate copolymer, and polyethylene terephthalate copolymer.

If a mixture of at least on polyamide and of at least one polyester is employed, the at least one polyamide and the at least on polyester are the same as described above.

In a mixture a polyamide-copolymer is used particularly preferred, too. Suitable polyamides are e.g. PA6, PA66, PA46, CoPA6/66, PA616. The portion of the at least one polyester mixed with the at least one polyamide is preferably in the range from 10 to 50% by weight, preferably in the range from 25 to 35% by weight, each based on the total weight of the plastics molding composition with low viscosity.

The hard plastics component is preferably a polymer selected from the group consisting of polycarbonate, polyamide, e.g. PA6, PA66, PA46, CoPA6/66, PA6/6, polyester, e.g. polybutylene terephthalate (PBT), polyethylene terephthalate (PET), polybutylene terephthalate copolymer, polyethylene terephthalate copolymer, polysulfide, e.g. polyphenylene sulfide (PPS), polysulfone (PSU), polyether sulfone (PES), polyether, e.g. polyphenyl ether (PPE), polyurethanes (PU), in each case unreinforced or reinforced with, for example, glass fibers, glass beads, minerals, such as talc, or impact modifiers, in each case individually or in combination, in a proportion of from 0 to 70% by weight, preferably from 5 to 60% by weight.

Examples of materials suitable as hard plastics component are PBT with 30% by weight of glass fibers, PA6 with 25% by weight of glass fiber, and 15% by weight of mineral or PA6 with 40% by weight of glass fiber, and impact modifiers.

The hard plastics component is preferably a thermoplastic whose tensile modulus of elasticity is at least 3000 MPa.

An advantage of the use of the plastics molding composition with the low viscosity is that the molecules of the plastics molding composition have relatively free movement during sheathing of the insert part in step (a) or during sheathing in step (d). By virtue of this, they can wet the surface of the insert part. During the cooling process, the freedom of movement of the molecules allows them to enter regions sufficiently close to the surface of the insert part to permit bonding. Formation of a gap between the insert part and the plastics jacket is thus avoided. The connection achieved is leakproof with respect to fluids from the environment. The connection between the insert part and the plastics molding composition with low viscosity can be produced mechanically or chemically. As an alternative, it is also possible, for example, to produce the connection between insert part and plastics molding composition with low viscosity via a mechanical connection.

For the purposes of the present invention, a leakproof connection means that the leakage rate is smaller than 0.1 cm³/min after a test using at least 200 cycles of atmospheric conditions where the component to be tested is subjected to a temperature alternating between −40° C. and +150° C. The leakage rate is usually determined by a differential-pressure method using a test pressure of 0.5 bar.

In one preferred embodiment, the sheathing of the insert part with the plastics molding composition which has low viscosity in step (a) takes place via an injection-molding process. For this, the insert part is placed in an injection mold. After placement of the insert part, the mold is closed, and the plastics molding composition is injected into the mold. By virtue of the low viscosity, the plastics molding composition becomes distributed on the insert part and forms a bond to the insert part. This produces, between the insert part and the plastics molding composition with the low viscosity, a bond which is leakproof with respect to fluids.

Injection of the plastics molding composition generally takes place here at the pressures conventional for injection molding. However, if deformation of the insert part can occur by virtue of non-uniform overmolding, for example, it is preferable that the injection of the plastics molding composition with the low viscosity preferably takes place at a maximum pressure in the mold of less than 900 bar, preferably of less than 600 bar. The low injection pressure avoids deformation of the insert part during overmolding. After the overmolding of the insert part, the plastics molding composition with the low viscosity hardens. A further advantage of the overmolding of the insert part with the plastics molding composition with low viscosity is that the plastics sheathing stabilizes the insert part.

After the sheathing with the plastics molding composition with the low viscosity, the sheathed insert part is sheathed with the hard plastics component. The sheathing with the hard plastics component preferably likewise takes place via an injection-molding process. The injection-molding process is usually carried out with the pressures conventional for injection molding. If the plastics molding composition has been injected with low injection pressure, the pressure in the mold here is generally higher than the maximum pressure in the mold in step (a). During injection of the hard plastics component, the plastics molding composition with the low viscosity usually undergoes incipient melting at its surface, thus producing a connection between the hard plastics component and the plastics molding composition with the low viscosity. This also produces, between the two polymers, namely the plastics molding composition with the low viscosity and the hard plastics component, a connection which is leakproof with respect to fluids from the environment.

The sheathing of the insert part with the plastics molding composition with low viscosity in step (a) and the sheathing of the sheathed insert part in step (b) can take place in the same injection mold. A requirement for this is that the injection mold initially encloses a cavity corresponding to the shape of the insert part with the plastics molding composition with low viscosity. The mold must then open in such a way that the free shape corresponds to the shape of the finished component. Appropriate molds are known to the person skilled in the art. However, it is also possible, as an alternative, that the sheathing of the insert part with the plastics molding composition with low viscosity takes place in a first mold, and the sheathing with the hard plastics component takes place in a second mold. A requirement in this case is that the insert part sheathed with the plastics molding composition is removed from the first mold and, prior to overmolding with the hard plastics component, placed in the second mold. In order to avoid deformation of the sheathing composed of the plastics molding composition with low viscosity, a requirement is that the plastics molding composition with low viscosity solidifies in the mold prior to removal to an extent that then prevents its further deformation.

To avoid the need to clean the injection-molding machine after each injection procedure, in order to change the material, it is preferable that two different injection-molding machines are used for the plastics molding composition with low viscosity and the hard plastics component. If the same mold is used for the sheathing in step (a) and the overmolding in step (b), it is possible for the mold to have simultaneous connection to both injection-molding machines. As an alternative, it is also possible to connect the mold initially to the injection-molding machine which injects the plastics molding composition with low viscosity and then to connect it to the injection-molding machine which overmolds the hard plastics component around the insert part with the sheathing composed of the plastics molding composition with low viscosity. Examples of conventional injection-molding machines used for this purpose are injection-molding machines with a turntable mold. These have, by way of example, the cylinders arranged opposite, and the mold is rotated in each case toward the cylinder from which the next material will be injected. If two different molds are used, each of these preferably has connection to an injection-molding machine. A suitable injection-molding machine here is any desired injection-molding machine known to the person skilled in the art.

It is possible that, in step (b), only parts of the insert part with the sheathing composed of the plastics molding composition with low viscosity are sheathed by the hard plastics component. In this case, it is preferable that the regions overmolded by the hard plastics component are those which have an external surface, since the hard plastics component ensures that the molding has dimensional stability. As an alternative, it is, of course, also possible that the entire insert part with the sheathing composed of the plastics molding composition with low viscosity is overmolded by the hard plastics component.

In that version of the process which comprises first in step (c) sheathing of the insert part with a hard plastics component, regions of the insert part here not being sheathed, and, in a second step (d), sheathing of the non-sheathed regions of the insert part with a plastics molding composition which has low viscosity, the sheathing of the insert part with the hard plastics component preferably takes place in such a way that the hard plastics component sheathes the insert part in the regions in which there are external surfaces. The regions which are overmolded with the plastics molding composition with low viscosity preferably have no outward-facing areas. This method ensures that the resultant component has geometric and dimensional stability.

The sheathing of the insert part with the hard plastics component in step (c) preferably takes place via an injection-molding process. For this, the insert part is placed in an injection mold and then overmolded with the hard plastics component. To avoid penetration of the hard plastics component into the regions intended to be excluded, the mold is in contact with the insert part in these regions.

After the sheathing of the insert part with the hard plastics component, the regions intended to be sheathed by the plastics molding composition with low viscosity are rendered accessible. For this, it is possible either to have movable parts provided in the mold which initially form the exclusions and then render the exclusions accessible for overmolding with the plastics molding composition which has the low viscosity, or to remove, from the mold, the insert part overmolded with the hard plastics component and to place it in a second mold, in which there are exposed regions intended for sheathing with the plastics molding composition with low viscosity. The sheathing with the plastics molding composition with low viscosity likewise preferably takes place via an injection-molding process. This is generally carried out at the pressures conventional for injection-molding processes. If distortion of the insert part can occur because of non-uniform overmolding, for example, the injection-molding process for the plastics molding composition with low viscosity is preferably carried out at a lower pressure than the injection-molding process used to overmold the hard plastics component around the insert part. The pressure for the sheathing with the plastics molding composition with low viscosity is then preferably below 900 bar, preferably below 600 bar. In an example of a method for producing a connection which is leakproof with respect to fluids between the hard plastics component and the plastics molding composition with low viscosity, the surface of the hard plastics component likewise undergoes incipient melting by the melt of the plastics molding composition, thus producing a leakproof connection between the plastics. A further possibility consists in chemically and/or mechanically connecting the plastics molding composition with low viscosity and the hard plastics component. By virtue of the low viscosity of the plastics molding composition with low viscosity, this wets the insert part in such a way that, after hardening, a bond is produced between the insert part and the plastics molding composition with low viscosity. This produces a connection which is leakproof with respect to fluids between the insert part and the plastics molding composition with low viscosity. As mentioned above, the insert part can enter into chemical and/or mechanical connection with the plastics molding composition with low viscosity.

The further object is achieved via a component, comprising an insert part and comprising plastics sheathing which is composed of at least two plastics components, where the first plastics component, which at least to some extent directly sheathes the insert part, is a plastics molding composition with low viscosity, and the second plastics component is a hard plastics component.

The fact that the insert part has been sheathed at least to some extent directly by the plastics molding composition with the low viscosity produces, between the insert part and the plastics molding composition, a connection which is leakproof to fluids with respect to the environment. The plastics molding composition with the low viscosity also simultaneously serves as adhesion promoter with respect to the hard plastics component. This, too, produces a connection which is leakproof to fluids between the hard plastics component and the plastics molding composition with the low viscosity. It is possible to produce a component which ensures leakproof properties with respect to fluids from the environment.

In one first embodiment, the design of the component is such that the plastics molding composition with the low viscosity at least to some extent sheathes the insert part, and that the hard plastics component at least to some extent encloses the plastics molding composition with the low viscosity. It is, of course, also possible that the plastics molding composition with the low viscosity has been enclosed entirely by the hard plastics component.

If, however, the plastics molding composition with the low viscosity has been only partially enclosed by the hard plastics component, the hard plastics component has preferably been arranged in those regions of the component which are external surfaces of the component. This ensures that the component has geometric and dimensional stability, since the hard plastics component can be processed with greater dimensional stability than the plastics molding composition with low viscosity.

In a second embodiment, the insert part has been at least to some extent directly sheathed by the hard plastics component. The plastics molding composition with the low viscosity directly encloses those regions of the insert part which have not been sheathed by the hard plastics component. The arrangement of the hard plastics component here is preferably such that those regions of the insert part that form external areas have been sheathed by the hard plastics component. The plastics molding composition with the low viscosity has been arranged in those regions of the insert part where no external areas are present. An advantage of this arrangement is, as described above, that it ensures that the component has dimensional stability at the external areas.

By way of example, the insert part is a stamped grid. In this case, the component can be used as a plug connector, for example. The insert part can moreover also be a wire, a round conductor, a flat conductor, a flexible foil, or a printed circuit board. If the component is used in the automobile industry sector, the insert part can, for example, also be a retaining strap, a door latch, a lock, a threaded bush, an antifriction bearing, a panel, a wire for stabilizers, or a component composed of diecast zinc or diecast aluminum for a door-securing unit. It is moreover also possible that the component is a blade for a knife, for scissors, for a scalpel, or else for a screwdriver.

The insert part has preferably been manufactured from a metal. Examples of suitable metals from which the insert part has been manufactured are copper and copper-containing alloys, such as CuSn6, CuSn0,15, CuBe, CuFe, CuZn37, CuSn4Zn6Pb3-C-GC (gunmetal) or CuZn39Pb3 (brass), aluminum and aluminum-containing alloys, such as AlSi12Cu1, AlSi10Mg, titanium, stainless steel, lead-free metals, and metal alloys, or materials with a tin coating.

The plastics molding composition with the low viscosity is, as described above, preferably a polyamide, particularly a polyamide copolymer, a polyester or a mixture of at least one polyamide and at least one polyester. The polyamide copolymer is preferably prepared from at least two monomers selected from the group consisting of caprolactam, adipic acid, hexamethylenediamine, and bis(4-aminocyclohexyl)methane. The polyamide copolymer has very particularly preferably been prepared from caprolactam, adipic acid, hexamethylenediamine, and bis(4-aminocyclohexyl)methane.

The hard plastics component is preferably a thermoplastic whose modulus of elasticity is at least 3000 MPa. Examples of suitable polymers for the hard plastics component are—as described above—polycarbonate, polyamide, polyester, polysulfide, polyether, polyurethane, in each case unreinforced or reinforced.

The inventive component is by way of example a plastics part as used in electronics. It is also possible that the inventive component is a mechatronic component or a plastics housing with plug contacts. Components of this type are used by way of example as sensors, for example as oil sensors, wheel-rotation-rate sensors, pressure sensor, etc., as electronics housings, as control housings, for example in the ABS sector, the ESP sector, the gearbox sector, the airbag sector, or in the engine-control system of motor vehicles. The components can also be used by way of example as window-lifter modules or for the headlamp control system. The inventive components can also be used outside of the automobile industry by way of example as sensors, as fill-level indicators, or as pipeline units.

Examples of other suitable uses for the inventive components are electronic components in household devices. Examples of suitable components are relays, coil formers, switch parts, magnetic valves, electrical hand tools, plug devices, or plug connectors.

Embodiments of the invention are shown in the drawings and explained in more detail in the description below.

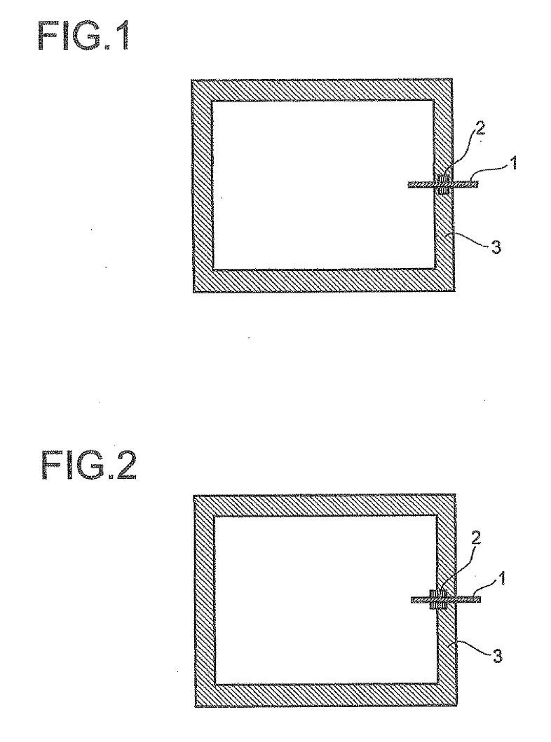

FIG. 1 shows a first embodiment of an inventively designed component, and

FIG. 2 shows a second embodiment of an inventively designed component.

FIG. 1 shows a first embodiment of an inventively designed component. Here, an insert part 1 manufactured by way of example from a metal has been sheathed by a plastics molding composition 2. This plastics molding composition has low viscosity.

An example of a suitable insert part 1 is a stamped grid, a wire, a round conductor, a flat conductor, a flexible foil, or a printed circuit board. The insert part can moreover also be, for example, a bush, an antifriction bearing, a panel, a component composed of diecast zinc or of diecast aluminum for a door-securing unit, or a blade for a knife, for scissors, for a scalpel, or for a screwdriver.

In the embodiment shown in FIG. 1, the plastics molding composition with the low viscosity has been entirely enclosed by a hard plastics component 3. As mentioned above, a plastic which is preferably dimensionally stable is used for the hard plastics component. Dimensionally stable components can thus be produced. Deformation of the component, even when small forces act thereon, is avoided.

FIG. 2 shows a second embodiment of an inventively designed component.

In this embodiment, the insert part 1 is first sheathed to some extent by the hard plastics component 3. The regions intended to be sheathed by the plastics molding composition 2 with low viscosity remain available. The plastics molding composition 2 with low viscosity is then introduced into the regions not covered by the hard plastics component. An advantage of this embodiment is that a dimensionally stable component is first produced and then the seal with respect to fluids is produced via the plastics molding composition 2 with low viscosity. The plastics molding composition 2 with low viscosity is applied here in such a way that it is in contact not only with the insert part but also with the hard plastics component.

As an alternative, the component shown in FIG. 2 can also be produced by first sheathing the insert part 1 to some extent with the plastics molding composition 2 with low viscosity. The plastics molding composition 2 with low viscosity is then to some extent sheathed by the hard plastics component 3.

In order to avoid deformation, the component 2, 3 first applied is preferably first solidified at least to some extent, thus making it dimensionally stable, before the second component 2, 3 is applied.

1.-17. (canceled)

18. A process for the production of a component comprising an insert part, sheathed by a plastics layer, which comprises the following steps:
(a) sheathing of the insert part with a plastics molding composition, wherein the plastics molding composition has a low viscosity with a viscosity number to ISO 307, measured in 96% strength sulfuric acid, being smaller than 140 ml/g, and
(b) sheathing of at least one part of the insert part with the sheathing composed of the plastics molding composition with a hard plastics component.

19. The process according to claim 18, wherein the sheathing of the insert part in step (a) takes place via an injection-molding process.

20. The process according to claim 19, wherein the maximum pressure in the mold is less than 900 bar during the injection-molding process.

21. The process according to claim 18, wherein the overmolding in step (b) talces place via an injection-molding process in which the maximum pressure in the mold is higher than the maximum pressure in the mold in step (a).

22. A process for the production of a component comprising an insert part, sheathed by a plastics layer, which comprises the following steps:
(c) sheathing of the insert part with a hard plastics component, regions of the insert part here not being sheathed, and
(d) sheathing of the non-sheathed regions of the insert part with a plastics molding composition, wherein the plastics molding composition has a low viscosity with a viscosity number to ISO 307, measured in 96% strength sulfuric acid, being smaller than 140 ml/g.

23. The process according to claim 22, wherein the sheathing of the insert part with the hard plastics component in step (c) takes place via an injection-molding process.

24. The process according to claim 22, wherein the sheathing of the non-sheathed regions with the plastics molding composition with low viscosity in step (d) takes place via an injection-molding process at a pressure below 900 bar.

25. The process according to claim 18, wherein the plastics molding composition which has the low viscosity is a polyamide, a polyester or a mixture of at least one polyamide and at least one polyester.

26. The process according to claim 25, wherein the polyamide is a polyamide copolymer.

27. The process according to claim 26, wherein the polyamide copolymer is composed of caprolactam, adipic acid, hexamethylenediamine, and bis(4-aminocyclohexyl)methane.

28. The process according to claim 18, wherein the hard plastics component is selected from the group consisting of polycarbonate, polyamide, polyester, polysulfide, polyether and polyurethane, in each case reinforced or unreinforced.

29. The process according to claim 18, wherein the hard plastics component is a thermoplastic whose tensile modulus of elasticity is at least 3000 MPa.

30. The process according to claim 22, wherein the plastics molding composition which has the low viscosity is a polyamide, a polyester or a mixture of at least one polyamide and at least one polyester.

31. The process according to claim 30, wherein the polyamide is a polyamide copolymer being composed of caprolactam, adipic acid, hexamethylenediamine, and bis(4-aminocyclohexyl)methane.

32. The process according to claim 22, wherein the hard plastics component is selected from the group consisting of polycarbonate, polyamide, polyester, polysulfide, polyether and polyurethane, in each case reinforced or unreinforced.

33. The process according to claim 22, wherein the hard plastics component is a thermoplastic whose tensile modulus of elasticity is at least 3000 MPa.

34. A component comprising an insert part and comprising plastics sheathing which is composed of at least two plastics components, where the first plastics component, which at least to some extent directly sheathes the insert part, is a plastics molding composition with low viscosity with a viscosity number to ISO 307, measured in 96% strength sulfuric acid, being smaller than 140 ml/g, and the second plastics component is a hard plastics component.

35. The component according to claim 34, wherein the plastics molding composition with the low viscosity at least to some extent sheathes the insert part, and the hard plastics component at least to some extent encloses the plastics molding composition with the low viscosity.

36. The component according to claim 34, wherein the hard plastics component at least to some extent directly sheathes the insert part, and the plastics molding composition with the low viscosity directly encloses regions of the insert part which have not been sheathed by the hard plastics component, and the plastics molding composition with the low viscosity has been arranged here in such a way that it is in contact not only with the insert part but also with the hard plastics component.

37. The component according to claim 34, wherein the insert part is a stamped grid, a wire, a round conductor, a flat conductor, a flexible foil, or a printed circuit board.

38. The component according to claim 34, wherein the insert part has been manufactured from a metal.

39. The component according to claim 34, wherein the plastics molding composition with the low viscosity is a polyamide, a polyester or a mixture of at least one polyamide and at least one polyester, and the hard plastics component is a thermoplastic whose modulus of elasticity is at least 3000 MPa.
